(19) United States
(12) Patent Application Publication
(10) Pub. No.: US 2014/0040195 A1
(43) Pub. Date: Feb. 6, 2014

(54) Offline Web Application System

(71) Applicants: Jeremiah ELLIOTT, Temple, TX (US); Stephen JOYNER, Temple, TX (US); Heath ROBINSON, Temple, TX (US)

(72) Inventors: Jeremiah ELLIOTT, Temple, TX (US); Stephen JOYNER, Temple, TX (US); Heath ROBINSON, Temple, TX (US)

(73) Assignee: INTEGRITY DIGITAL SOLUTIONS, LLC, Temple, TX (US)

(21) Appl. No.: 13/563,514

(22) Filed: Jul. 31, 2012

(51) Int. Cl. G06F 17/30

(52) U.S. Cl. 707/617; 707/E17.032

(57) ABSTRACT

The present invention provides a method and system for providing offline functionality for a web-based application. The client, data broker and remote server process read requests and create, delete or update commands they receive according to logic and network hierarchy. Periodic caching of data structures needed in the future further improves the offline functionality.

### BACKGROUND OF THE INVENTION

1. Technical Field

The present invention relates to enabling the use of web-based applications when its web server is offline.

2. Description of Related Art

In recent years many businesses and other organizations have increasingly utilized data storage and computer programs that operate on remote servers accessed via the Internet. A web-based application allows web browsers to interact with data on a remote database located on a server that is accessible over the Internet. With the continually dropping costs of data storage and bandwidth, the use of web-based applications has become a more economic option for such organizations and will continue to become economic for an increasing number of potential users.

The advantages of using web-based applications are many. They include the ability to access data from any computer with a web-browser, backup and safety by protecting data from local problems (e.g., office fires, electrical surges/lightning strikes, etc.), as well as alleviating users from the need to continually manage and update local versions of computer programs.

However, use of web-based applications to access data on remote servers has its disadvantages, mostly related to the inability of users to retrieve data from those remote servers when the Internet is down (which is sometimes referred to as offline). While the stability and security of the Internet access continues to increase, there are times when one of the links in the chain between a local computer and a remote server is broken. As a result, despite the advantages of web-based applications versus purely local computing, a user of a web-based application can experience significant services outages because of the inability of web-based applications to operate offline.

### SUMMARY OF THE INVENTION

The present invention is a method and system for providing offline functionality for web-based applications. In one embodiment, a method for enabling offline functionality for a web-based application configured to create, delete and update data structures in a database, wherein said web-based application is configured to run on a local area network (LAN) client comprises:
(a) providing a data broker within said LAN and linked to said client;
(b) for a data structure read request originating from said web-based application, processing said read request according to the following steps:
   (i) checking said client for said data structure;
   (ii) if said data structure is unavailable on said client, checking said data broker for said data structure;
   (iii) if said data structure is unavailable on said data broker, checking a remote server linked to said LAN by the Internet for said data structure,
   (iv) if said data structure is unavailable on said client, said data broker and said remote server, informing said client that said data structure is unavailable;
   (v) if said data structure is available on said client, said data broker, or said remote server, delivering said data structure to said client; and
   (vi) registering interest in said data structure on each of said client, said data broker and said remote server, if not already interested;
(c) for a create, delete and update (CDU) command received by said client, said data broker or said remote server, processing said CDU command according to the following steps:
   (i) registering interest in said data structure on each of said client, said data broker and said remote server if not already interested;
   (ii) if said CDU command is a delete or update command, retrieving said data structure according to said steps (b)(i)-(b)(vi);
   (iii) executing said CDU command against an immediately previous version of said data structure, if any;
   (iv) recording said CDU command in a log;
   (v) notifying any other clients that are already interested in said data structure;
   (vi) sending said CDU command to a next level data cache in a network hierarchy, wherein said network hierarchy comprises client/data broker/remote server, if said CDU command has not already reached its final destination in said network hierarchy.

In another embodiment, at predetermined time intervals, said data broker caches at least one data structure needed during each successive time interval. In still another embodiment, under step (c) above, the step of holding said CDU command in queue when said next level data cache or any said clients already interested in said data structure are unavailable, and retrying said sending or notifying steps at predetermined time intervals.

In another embodiment, for said read request or said CDU command, deregistering interest after said data structure is delivered or said CDU command is executed, respectively. In still another embodiment, said deregistering interest occurs in response to a user command.

Another embodiment comprises computer executable instructions configured to execute one or more of the methods described above.

In one embodiment, a system enabling offline functionality for a web-based application configured to create, delete and update data structures in a database, wherein said web-based application is configured to run on a local area network (LAN) client, comprises:
a data broker within said LAN and linked to said client and a remote server, wherein said client, said data broker, and said remote server comprise a network hierarchy comprising client/data broker/remote server, wherein said client, said data broker, and said remote server are configured to process a data structure read request originating from said web-based application as follows:
   (i) checking said client for said data structure;
   (ii) if said data structure is unavailable on said client, checking said data broker for said data structure;
   (iii) if said data structure is unavailable on said data broker, checking a remote server linked to said LAN by the Internet for said data structure,
   (iv) if said data structure is unavailable on said client, said data broker and said remote server, informing said client that said data structure is unavailable;
   (v) if said data structure is available on said client, said data broker, or said remote server, delivering said data structure to said client; and
   (vi) registering interest in said data structure on each of said client, said data broker and said remote server, if not already interested; and
wherein said client, said data broker, and said remote server are configured to receive a create, delete and update (CDU) command and process said CDU command as follows:
   (vii) registering interest in said data structure on each of said client, said data broker and said remote server if not already interested;
   (viii) if said CDU command is a delete or update command, retrieving said data structure according to said steps (i)-(vi);
   (ix) executing said CDU command against an immediately previous version of said data structure, if any;
   (x) recording said CDU command in a log;
   (xi) notifying any other clients that are already interested in said data structure;
   (xii) sending said CDU command to a next level data cache in said network hierarchy if said CDU command has not already reached its final destination in said network hierarchy.

In another embodiment, at predetermined time intervals, said data broker caches at least one data structure needed during each successive time interval. In still another embodiment, said client, said data broker and said remote server hold said CDU command in queue when said next level data cache or any said clients already interested in said data structure are unavailable, and retry said sending or notifying steps at predetermined time intervals.

In another embodiment, the system comprises a second client configured to process a read request and a CDU command according to (i)-(xii).

In one embodiment, the system comprises an electronic medical records management system according to any of the systems described above, wherein said data structures are patient records.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram showing the computer architecture capable of carrying out one embodiment of the present invention;

FIG. 2 is a flowchart showing the processing steps for a read request according to one embodiment of the present invention;

FIG. 3 is a flowchart showing the processing steps for a create, delete or update command according to one embodiment of the present invention

### DETAILED DESCRIPTION

The present invention allows web-based applications to work offline. As used herein, a web-based application is a computer program comprising computer-executable instructions running or configured to run on a computer linked to a local area network (LAN), which a user can access and interact with using a web browser, and which is configured to transmit and receive data from a remote computer linked to the LAN via the Internet or similar remote network.

Embodiments of the present invention may comprise a general-purpose or special-purpose computer, which may include computer hardware, as discussed in greater detail below. Some embodiments may also include computer-readable media capable of storing computer-executable instructions or data structures. Such computer-readable media can be any available media that can be accessed by a general-purpose or special-purpose computer. For example, computer-readable media can include physical computer-readable storage media, such as, RAM, ROM, EPROM, EEPROM, CD-ROM, DVD, or other optical disk storage, magnetic disk storage or other magnetic storage devices, or any other medium which can be used to store program code means in the form of computer-executable instructions or data structures and which can be accessed by a general purpose or special purpose computer.

As used in this description and the claims, a “network” is defined as at least one data link that enables electronic data transport between computer systems or individual modules of computer systems. Individual modules of computer systems or networks are sometimes referred to as clients. When information is transferred or provided over a network or another communications connection (whether wireless, hardwired, or a combination of the two) to a computer, the computer properly views the connection as a computer-readable medium. Thus, for example, computer-readable media can also include a network or data links which can be used to transmit, provide, receive or store desired program code means in the form of computer-executable instructions or data structures and which can be accessed by a general purpose or special purpose computer.

Computer-executable instructions can comprise, for example, instructions and data which cause a general purpose computer, special purpose computer, or special purpose processing device to perform a specific function or group of functions. The computer-executable instructions may be, for example, binary code, intermediate format instructions such as assembly language, or even source code. Although the subject matter has been described in language specific to structural features and/or methodological acts, it is to be understood that the subject matter defined in the appended claims is not necessarily limited to the described structural features or acts described herein. Instead, the described structural features and acts are disclosed as example embodiments of implementing the claims.

Practitioners of the present invention will appreciate that it may be practiced in network computing environments with many different types of computer systems and configurations, including, without limitation, personal computers (PCs), desktop computers, laptop computers, servers, message processors, hand-held devices, multi-processor systems, microprocessor-based or programmable consumer electronics, network PCs, minicomputers, mainframe computers, mobile telephones, PDAs, and pagers. The invention may also be practiced in distributed system environments where local and remote computer systems, which are linked (whether by hardwired data links, wireless data links, or a combination of links) through a network, both perform tasks. In a distributed system environment, program modules may be located in both local and remote memory storage devices.

In one embodiment of the present invention, a system comprises a data broker in electronic communication with or linked to a local area network (LAN). The data broker is configured to provide computers linked to the same LAN with offline functionality for web-based applications running on a web browser, any synchronize any database updates made using such web-based application with other web browsers on the same LAN. In another embodiment, a method of providing offline functionality for web-based applications comprises in response to a user request to create, change or delete a data structure.

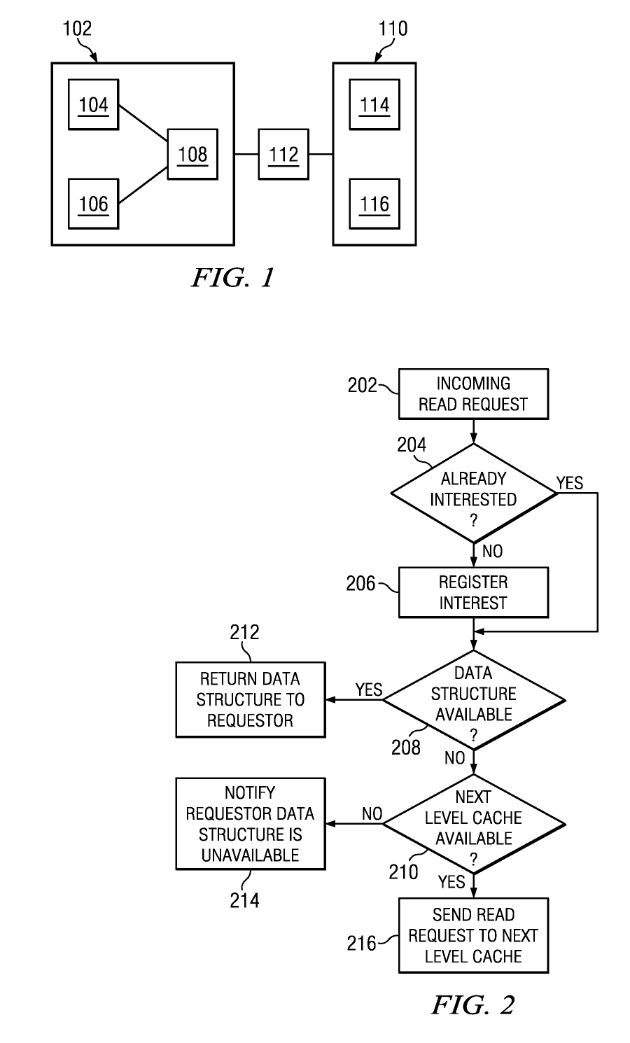

FIG. 1 depicts one embodiment of computer network architecture that facilitates offline access to web-based application data. LAN 102 comprises clients 104 and 106 linked to data broker 108. The data broker 108 can comprise a computer system that is separate from clients 104 and 106, such as a network server, or can comprise computer executable code residing on client/computer 104, 106, or other computer system linked to the LAN 102. The data broker 108 is configured to electronically communicate with one or more remote computer systems or servers 110 via the Internet, World Wide Web or similar remote access network. In the example of FIG. 1, remote computer systems comprise remote servers 114 and 116.

FIG. 2 depicts a flowchart of method steps used by one embodiment of the present invention. The principles of the present invention will be described with respect to a web-based application configured to allow a user to create, modify or delete a plurality of data structures stored in a database on at least one remote server. In preferred embodiments, the database is a text-based database, such as those based on the JSON or XML standards and protocols. The web-based application and all logic operations described herein are executed by computer-executable instructions or code stored or running on a computer's computer-readable media.

In this example, if a user of a web-based application running on a first client connected to the LAN makes read request 202 for a specific data structure, the first client first checks whether it is already interested 204 in that data structure. If the first client is not already interested, it registers its interest 206 in the data structure. The first client then checks whether the requested data structure is available 208 on its local cache. Data structures may be stored locally, for example, on local storage media or in an HTML5 database. If the data structure is available, it is delivered 212 to the client and web-based application.

If the data structure is not available on the first client's local cache, the read request is sent 216 to the next level data cache if available 210—the data broker. Upon receiving the read request, the data broker will check whether it is already interested 204 in the data structure. If the data broker is not interested in the data structure, the data broker will register interest 206 in the data structure. Next, the data broker checks whether the data structure is already available 208 on the data broker. If the data structure is available, the data broker returns 212 the data structure to the first client.

If the data structure is not available on the data broker, the read request is sent 216 to the next level data cache if available 210—a first remote server linked to the LAN over the Internet or similar remote network. Upon receiving the read request 202, the first remote server will check whether it is already interested 204 in the data structure. If the first remote server is not interested in the data structure, the first remote server will register interest 206 in the data structure. Next, the first remote server checks whether the data structure is already available 208 on the first remote server. If the data structure is available, the first remote server returns 212 the data structure to the data broker, which passes it on to the first computer.

If the data structure is not available on the first remote server, the read request is sent 216 to the next level data cache if available 210—a second remote server—a backup server or final location—and treated in a similar manner as it was treated by the first remote server.

If at any point along this line the client, data broker or remote server determines that the next level data cache is unavailable, or in the case of the second remote server (final location) that the data structure is unavailable and there is no next level data cache, the requestor is notified 214 that the data structure is unavailable.

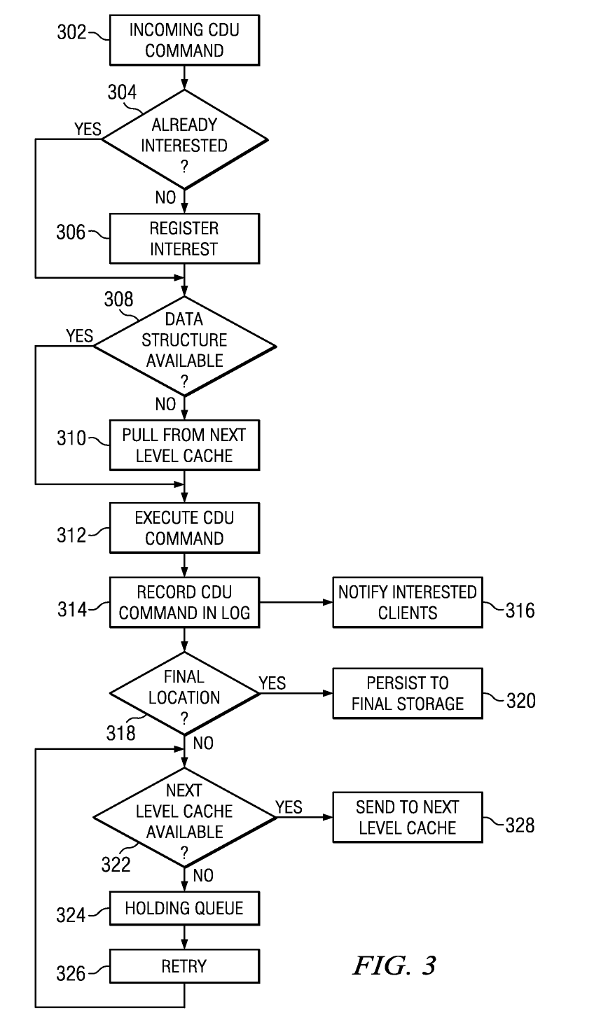

When a user of the web-based application creates, deletes or updates a data structure through the user interface of the application, the application generates a create/delete/update (CDU) command, which is handled by the various computers linked to the LAN in a manner similar to but more complex than the read request described above. A flowchart showing how a CDU command is processed according to one embodiment is depicted in FIG. 3.

When a first client running the web-based application receives a CDU command 302 for a data structure from the application, it is assigned an identification number, which is usually indicative of the time it was created, such as the number of milliseconds since Jan. 1, 1970. The first client checks whether it is already interested 304 in the data structure, and registers interest 306 if it is not already interested. The CDU command then drops into a queue (not shown), which processes the CDU commands in a “first-in-first-out” (FIFO) order against the immediately previous version of that data structure (if any).

When the CDU command emerges from the queue and is a delete or update command, the data structure, if not already available 308 on the first client, is retrieved from the next level data cache 310, as described above for read requests, including each level registering interest in that data structure. After the data structure has been retrieved (if necessary), the CDU command is executed 312 on the first client. If the CDU command is the originating command (as it is from the first client in this example), it is assigned a checksum number (not shown). If the CDU command is not the originating command, the checksum is recalculated and verified (not shown). In the event the checksum is not verified at any point in the network hierarchy, the user is notified to reload the data structure (not shown). If the checksum is new or verified, the CDU command is stored in a CDU command log 314.

The CDU command processing logic on the first client then checks to see if other computers linked to it are interested in the data structure and notifies any interested clients 316. Because the first client is a CDU command originator, it will be the only computer interested in the data structure, and will determine that no other computers linked to it are interested in the data structure.

The CDU command processing logic on the first client will then check whether the CDU command has reached its final location 318 in the network hierarchy, and if not, whether the CDU command queue of next level data cache in the network hierarchy is available 322. If it is, the CDU command is sent to the next level cache 328 and placed in the queue at the next level data cache and processed as described above. In this example, the data broker is the next level data cache in the network hierarchy. It will process the CDU command as described above, including registering its own interest and checking for other interested clients it is linked to. Finding none (yet, in this example), the data broker will send the CDU command on to the next level data cache, which in this example is a first remote server.

In this example, assuming the Internet or other remote network is functioning, the first remote server will process the CDU command as described above. However, if the Internet is not functioning or the first remote server is otherwise unavailable, the data broker will place the CDU command in a holding queue 324. At predetermined times or time intervals, the holding queue will retry 326 sending the CDU command to the next level data cache. When the next level data cache becomes available, the held CDU commands are transmitted in FIFO order. Once the CDU command reaches its final destination, the process is terminated.

The present invention can be illustrated by taking the above example one step further. If a user on a second client linked to the same data broker as the first client opens the same web-based application and generates a CDU command for the same data structure, it will proceed through to the final destination as described above. The only difference is that the data broker will also send the CDU command to the first client, because the first client has registered interest in that data structure. This aspect of the CDU command processing operations described above is what enables offline functionality of the web-based application for multiple computers linked together by the same LAN.

Taking again the extended example of a CDU command generated from a second client for the same data structure, if the Internet is offline, or the remote servers are otherwise unavailable, the data structure is automatically updated on all computers attached to the LAN which are interested in the data structure. Furthermore, because all computers on the LAN send requests for data structures through the data broker first (if not already available locally), even computers that are not interested in the data structure when the remote servers become unavailable can still access them because they are always updated on the data broker when a change is made by any client on the LAN. Additionally, even multiple changes to the same data structure made from different computers on the same LAN will ultimately be reflected in databases on the remote servers because the holding queue will send them in FIFO order as soon as the remote servers become available again. Also, the CDU command log operations allow a user of the present invention to review how a particular data structure has changed over time by reversing the CDU commands in the log.

The offline functionality for web-based applications as described above is particularly useful in electronic medical record management systems. Many times, a patient in a doctor's office will be examined or treated in more than one room, and a different computer will be used in each room to update the patient's records. Also, the doctor or nurses may update the patient's record from an office or other room using still another computer. The offline functionality described above will enable accurate record keeping using a web-based electronic medical records management application even when the Internet is not functioning. The offline functionality will also be invisible to the user, unless the web-based application informs the user that it is running in offline mode.

The present invention also comprises an additional optional feature that enhances the offline functionality described above, especially when a user of the system can predict when a particular data structure will be needed. Again, in the medical records management field, doctors will typically know at least one day ahead of time when a patient will be seen because most patients have appointments. Therefore, the user can instruct the data broker to automatically retrieve all data structures that are anticipated to be needed for a predetermined time period into the future. The data structures can be automatically retrieved at predetermined times or time intervals, such as every evening, as such structures will be needed during each successive time interval.

The computers and/or data broker linked to a particular LAN can also deregister from data structures the user is no longer interested in. For example, in the electronic medical records management system, at the approximately the same time the data broker retrieves the data structures for which user access is anticipated for the following day, the data broker may also deregister interest in the data structures used during the previous day. The computers and/or data broker may also be set to automatically deregister interest in a data structure if it has not been accessed or changed within a predetermined period of time, or automatically deregister the oldest data structures when local storage of data structures is nearing full capacity. Additionally, the web-based application can allow a user to deregister interest in a data structure. Therefore, in one embodiment, the deregistering step occurs in response to a user command.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A method for enabling offline functionality for a web-based application configured to create, delete and update data structures in a database, wherein said web-based application is configured to run on a local area network (LAN) client, the method comprising:
(a) providing a data broker within said LAN and linked to said client;
(b) for a data structure read request originating from said web-based application, processing said read request according to the following steps:
(i) checking said client for said data structure;
(ii) if said data structure is unavailable on said client, checking said data broker for said data structure;
(iii) if said data structure is unavailable on said data broker, checking a remote server linked to said LAN by the Internet for said data structure,
(iv) if said data structure is unavailable on said client, said data broker and said remote server, informing said client that said data structure is unavailable;
(v) if said data structure is available on said client, said data broker, or said remote server, delivering said data structure to said client; and
(vi) registering interest in said data structure on each of said client, said data broker and said remote server, if not already interested;
(c) for a create, delete and update (CDU) command received by said client, said data broker or said remote server, processing said CDU command according to the following steps:
(i) registering interest in said data structure on each of said client, said data broker and said remote server if not already interested;
(ii) if said CDU command is a delete or update command, retrieving said data structure according to said steps (b)(i)-(b)(vi);
(iii) executing said CDU command against an immediately previous version of said data structure, if any;
(iv) recording said CDU command in a log;
(v) notifying any other clients that are already interested in said data structure;
(vi) sending said CDU command to a next level data cache in a network hierarchy, wherein said network hierarchy comprises client/data broker/remote server, if said CDU command has not already reached its final destination in said network hierarchy.

2. The method according to claim 1 wherein, at predetermined time intervals, said data broker caches at least one data structure needed during each successive time interval.

3. The method according to claim 1, further comprising under step (c), the step of holding said CDU command in queue when said next level data cache or any said clients already interested in said data structure are unavailable, and retrying said sending or notifying steps at predetermined time intervals.

4. The method according to claim 1, further comprising, for said read request or said CDU command, deregistering interest after said data structure is delivered or said CDU command is executed, respectively.

5. The method according to claim 1 wherein said deregistering interest occurs in response to a user command.

6. Computer executable instructions configured to execute the method of claim 1.

7. A system enabling offline functionality for a web-based application configured to create, delete and update data structures in a database, wherein said web-based application is configured to run on a local area network (LAN) client, the system comprising:
a data broker within said LAN and linked to said client and a remote server, wherein said client, said data broker, and said remote server comprise a network hierarchy comprising client/data broker/remote server, wherein said client, said data broker, and said remote server are configured to process a data structure read request originating from said web-based application as follows:
(i) checking said client for said data structure;
(ii) if said data structure is unavailable on said client, checking said data broker for said data structure;
(iii) if said data structure is unavailable on said data broker, checking a remote server linked to said LAN by the Internet for said data structure,
(iv) if said data structure is unavailable on said client, said data broker and said remote server, informing said client that said data structure is unavailable;
(v) if said data structure is available on said client, said data broker, or said remote server, delivering said data structure to said client; and
(vi) registering interest in said data structure on each of said client, said data broker and said remote server, if not already interested; and
wherein said client, said data broker, and said remote server are configured to receive a create, delete and update (CDU) command and process said CDU command as follows:
(vii) registering interest in said data structure on each of said client, said data broker and said remote server if not already interested;
(viii) if said CDU command is a delete or update command, retrieving said data structure according to said steps (i)-(vi);
(ix) executing said CDU command against an immediately previous version of said data structure, if any;
(x) recording said CDU command in a log;
(xi) notifying any other clients that are already interested in said data structure;
(xii) sending said CDU command to a next level data cache in said network hierarchy if said CDU command has not already reached its final destination in said network hierarchy.

8. The system according to claim 7 wherein, at predetermined time intervals, said data broker caches at least one data structure needed during each successive time interval.

9. The system according to claim 7, wherein said client, said data broker and said remote server hold said CDU command in queue when said next level data cache or any said clients already interested in said data structure are unavailable, and retry said sending or notifying steps at predetermined time intervals.

10. The system of claim 7 further comprising a second client configured to process a read request and a CDU command according to (i)-(xii).

11. An electronic medical records management system according to claim 7, wherein said data structures are patient records.
